(19) United States
(12) Patent Application Publication
(10) Pub. No.: US 2007/0294016 A1
(43) Pub. Date: Dec. 20, 2007

(54) Motor Vehicle and Associated Electronic Control Device

(75) Inventors: Harald Braun, Dettenhausen (DE); Norbert Ebner, Ludwigsburg (DE); Heiko Mayer, Adelmannsfelden (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLER CHRYSLER AG, STUTTGART (DE)

(21) Appl. No.: 10/558,698

(22) PCT Filed: Apr. 28, 2004
(86) PCT No.: PCT/EP04/04451

§ 371 Date: Feb. 28, 2007

(30) Foreign Application Priority Data
May 30, 2003 (DE) 103 24 573.1

(51) Int. Cl. G06F 17/00

(52) U.S. Cl. 701/67

(57) ABSTRACT

Motor vehicle (2) and associated electronic control device (4) for controlling an internal combustion engine (6) and at least one electrical machine (8). Torque losses of the electrical machine (8) are taken into account with the aid of families of characteristics and algorithms, and torques are predetermined for the electrical machine (8) independently of the operating state of the entire drive train (10) of the motor vehicle (2).

The invention relates to a motor vehicle and to an associated electronic control device. The invention relates in particular to an electronic motor vehicle control device for controlling an internal combustion engine and at least one electrical machine, both of which are connected or can be connected for drive purposes to a propulsion train in the motor vehicle, in which case the electrical machine can be operated at least as a generator, but preferably also as an electric motor.

A motor vehicle drive apparatus of this type is known from DE 100 46 631 A1, which discloses a method for controlling a generator in a motor vehicle, with a generator feeding a vehicle power supply system having loads and having at least one battery. In a recuperation standby mode, the nominal value of the generator output voltage is predetermined as a function of driving state variables such that electrical power is fed into the vehicle power supply system during braking or when the vehicle is in the overrun mode. The generator voltage governs the direction and the magnitude of the electrical charge flow to the battery, thus resulting in charging cycles and discharge cycles. Furthermore, DE 43 07 907 A1 proposes that the generator voltage be reduced during acceleration of the motor vehicle in order to reduce the load on the internal combustion engine, and that the generator voltage be increased during braking of the motor vehicle, in order that the generator can absorb more power in order to charge the battery by recuperation of braking energy.

The power flow between the battery, the generator and the loads is controlled by matching the preset nominal value of the generator voltage to the driving state of the motor vehicle.

One aim of the invention is to achieve the object of making use of the torques which can be produced by an electrical machine, in particular in its generator mode, with better efficiency.

According to the invention, this object is achieved with the aid of at least one family of characteristics and with the aid of algorithms which are stored in the electronic control device and allow the electronic control device to calculate and produce signals.

The two functions (families of characteristics and algorithms) allow torque losses of the generator to be included in the torque losses of the overall drive train, and it is possible to take account of the range of possible torque values of the generator for torque control in the drive train.

It is also possible to predetermine torques, which are defined as a function of the operating state of the overall drive train, as a nominal value for the generator, and to set these.

According to one embodiment of the invention, referred to in the following text as embodiment “A”, the stated object is achieved in that at least one diagram is stored in the control device, representing the relationship between a large number of rotation speed values, field current values and torque values of the electrical machine in each case as a generator for at least one specific vehicle power supply system voltage value, and in that the control device is designed in order to determine the associated instantaneous drag torque actual value of the electrical machine as a generator from the diagram data on the basis of in each case one rotation speed value and one field current value, with the control device being designed in order to use the respective instantaneous rotation speed actual value and the instantaneous field current actual value of the electrical machine for this purpose.

### Advantage of Embodiment A

Drag torques are produced in a motor vehicle drive train, in particular by the electrical machine when it is being operated as a generator and by a climate control system which may be present in the motor vehicle. The torques which are specified by the manufacturer of the electrical machine are highly imprecise, so that even machines of the same type for which the same torques are specified are subject to major torque discrepancies from the stated data. The invention has the advantage that the torques, in particular the drag torques, of the electrical machine are calculated accurately on the basis of respective instantaneous actual operating values. This makes it possible to eliminate or reduce torque margins for the internal combustion engine (the torque produced by the internal combustion engine to cover an external torque demand on the motor vehicle by the driver or an automatic speed sensor).

Further features of the invention relating to the embodiment A are included in the dependent claims 2 to 7.

According to another preferred embodiment of the invention, referred to in the following text as embodiment “B”, the stated object is achieved in that at least one diagram is stored in the control device, representing the relationship between a large number of rotation speed values, field current values and torque values of the electrical machine in each case as a generator for at least one specific vehicle power supply system voltage value, and in that the control device is designed in order to determine the associated field current value from the diagram data on the basis of in each case one rotation speed value and one torque value, with the control device being designed in order to use for this purpose a value which corresponds to the respective instantaneous rotation speed actual value of the electrical machine, and at the same time to use a torque value which is dependent on an external torque demand to the vehicle, with the control device then passing to the electrical machine a field current value which corresponds to that torque value, in order for the electrical machine to at least partially satisfy the external torque demand.

Special versions of embodiment B are contained in the dependent claims 9 to 16.

### Advantages of Embodiment B

When the electrical machine is in the recuperation mode (the electrical machine is being used as a generator for braking the motor vehicle and for generating electricity from the energy of motion of the motor vehicle) and when the load on the internal combustion engine is reduced by reducing the drag torque of the electrical machine, when it is being operated as a generator, or by the use of the electrical machine as an electric motor, for example immediately after starting of the internal combustion engine or during acceleration of the motor vehicle, this is only ever a torque demand, and not a voltage demand. If the torque of the electrical machine is subject to open-loop or closed-loop control by presetting electrical voltage values, then the actual torque values of the electrical machine are very highly and unpredictably dependent on the respective state of charge of the electrical battery to which the electrical machine and the motor vehicle power supply system are connected. The invention has the advantage that the electrical machine can be subjected to open-loop or closed-loop control by means of torque presets. This results in the electrical machine always having the same behavior, which is thus reproducible, depending on a predetermined torque; furthermore, the behavior of the motor vehicle is always the same for specific torque demands, so that the driver can become used to the behavior of the motor vehicle and is not subject to any unpredictable vehicle reactions.

The two embodiments A and B can be used independently of one another, or in combination with one another. When the embodiment A is also used with the embodiment B, then this results in the further advantage that more accurate values for the open-loop or closed-loop control of the electrical machine and internal combustion engine are available from the embodiment A, for the embodiment B.

The control devices for both embodiments A and B are designed for clocked checking and calculation of the relevant values, and include an electronic timer for this purpose.

The electrical machine is connected or can be connected to the propulsion train of the motor vehicle for drive purposes. This drive connection normally forms a step-up ratio that is not 1:1, but is such that the electrical machine rotates at a higher speed than the propulsion train, for example at a rotation speed that is three times higher. This allows the electrical machine to be connected to the propulsion train at any desired point, for example between the internal combustion engine and a variable speed transmission in the propulsion train. The step-up ratio in this drive connection for the electrical machine is taken into account by the control device in the calculation of the rotation speed of the electrical machine by means of an appropriate step-up factor. When the electrical machine is connected to the propulsion train by means of the drive connection between the variable speed transmission and the driven wheels, then it is also necessary for the control device to take into account a step-up factor from the variable speed transmission.

The invention relates to an electronic control device of the described type and to propulsion trains equipped with it as well, and to motor vehicles equipped in this way.

The invention will be described in the following text using preferred embodiments and with reference to the attached drawings, in which:

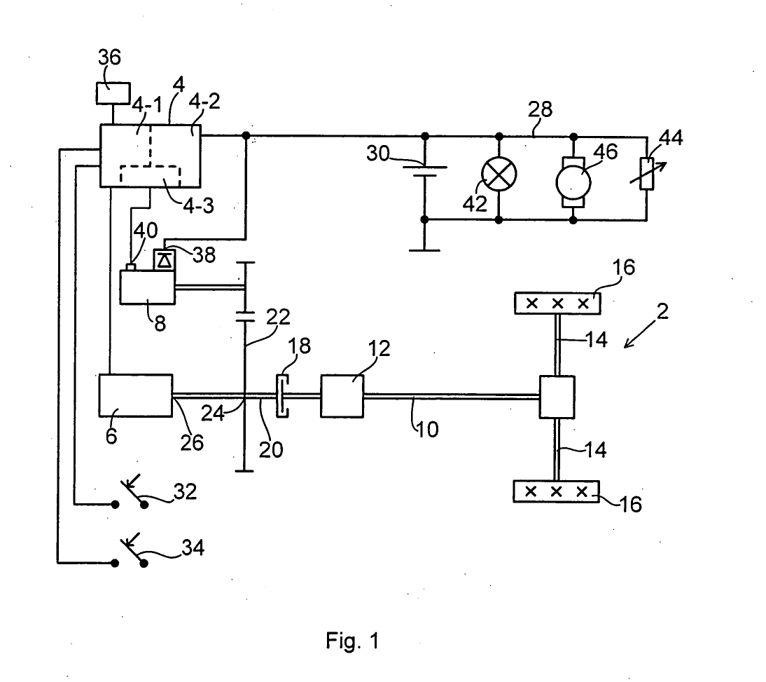

FIG. 1 shows, schematically, a motor vehicle with an electronic control device according to the invention,

FIG. 2 shows a diagram of data, which is stored in the electronic control device and can be read or calculated as a diagram, by means of an algorithm, and

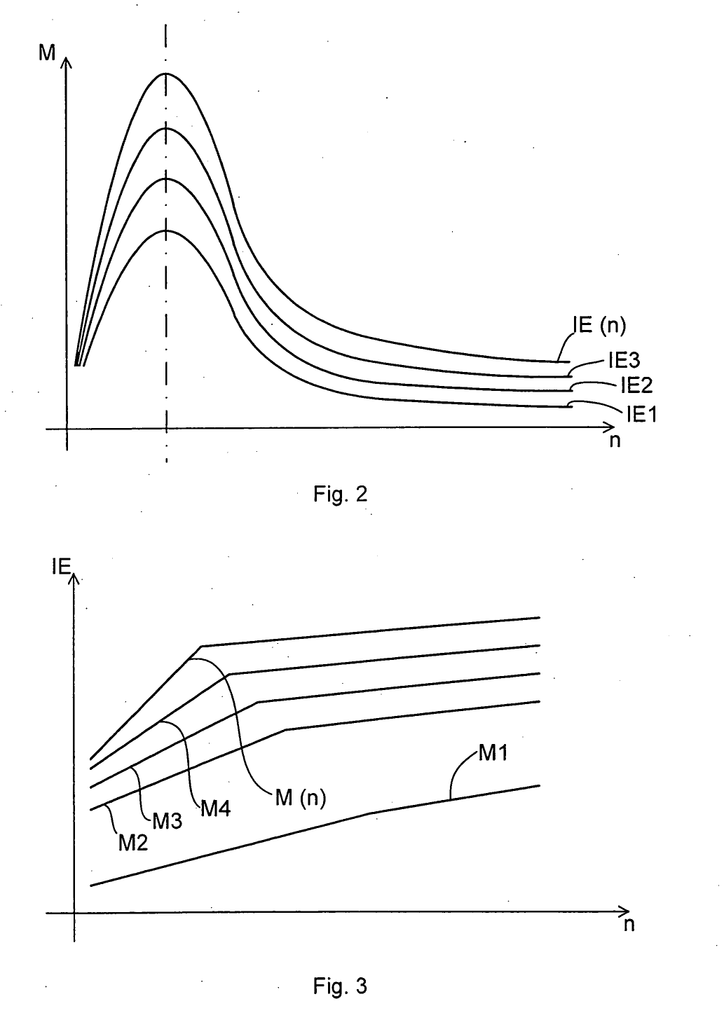

FIG. 3 shows a further diagram with data which is stored in the electronic control device and can be read or calculated as a diagram by means of an algorithm.

FIG. 1 shows, schematically, parts of a motor vehicle 2 and an electronic control device 4 for controlling an internal combustion engine 6 and at least one electrical machine 8. The internal combustion engine 6 is connected or can be connected via a propulsion train 10, which preferably includes a variable-speed step-up transmission 12, to at least one drivable vehicle axle 14, for driving the vehicle wheels 16, for drive purposes. A clutch 18, which can be engaged and disengaged, is preferably provided in the drive train section 20 between the internal combustion engine 6 and the transmission 12.

The electrical machine 8 is connected or can be connected for drive purposes via a drive connection 22, for example a transmission gear, to the propulsion train 10, preferably at a point 24 which is located between the internal combustion engine 6 and the clutch 18 which can be engaged and disengaged. According to another embodiment, this point 24 could also be located between the clutch 18 and the transmission 12, or between the transmission 12 and the drivable vehicle axle 14. In this case, not only the step-up ratio of the drive connection 22 but also the step-up ratio of the transmission 12 between the transmission input and the transmission output must be taken into account for the rotation speed of the electrical machine 8 relative to the rotation speed of the crankshaft 26 of the internal combustion engine 6. In an embodiment of the type illustrated in FIG. 1, the step-up ratio of the drive connection 22 is preferably approximately 1:3, so that the electrical machine is rotating approximately three times as fast as the crankshaft 26 of the internal combustion engine 6. According to one preferred embodiment, the control device 4 identifies the respective instantaneous rotation speed of the electrical machine 8 from the series of sparks or from the crankshaft rotation speed of the internal combustion engine 6.

The electronic control device 4 may be in the form of a single appliance or in the form of a plurality of appliances. As is indicated only schematically, the control device contains an engine controller 4-1 for controlling the internal combustion engine 6, a vehicle power supply system controller 4-2 for controlling a vehicle power supply system 28, in particular the state of charge of one or more batteries 30, and a coordinator 4-3 for open-loop or closed-loop control of the internal combustion engine 6 and of the electrical machine 8 as a function of the electrical state of the vehicle power supply system 28 and/or of its battery 30 on the one hand, and of external torque demands to the vehicle on the other hand. External torque demands may be passed to the vehicle, for example by a driver, via an accelerator pedal 32 and a brake pedal 34, or by means of a cruise control device 36, which are connected to the control device 4 via control lines. The cruise control device may, for example, be designed to maintain a constant vehicle speed irrespective of changing resistances to travel, for example when traveling uphill and downhill. One such cruise control system is known by the name “Tempomat”Furthermore, the cruise control device 36 may be designed in order to brake the vehicle as a function of the distance to obstructions in front of the vehicle, or to be accelerated again when there are no obstructions. However, the invention can also advantageously be used when no automatic cruise control device 36 is provided.

The electrical machine 8 has an electricity generator output 38, which may be a signal-phase or polyphase output and is electrically connected to the vehicle power supply system 28. Furthermore, the electrical machine 8 has a field winding connection 40, which is electrically connected to the electronic control device 4, preferably to its coordinator 4-3.

The vehicle power supply system 28 includes, for example, internal lighting and external lighting, which are represented schematically by 42. Furthermore, it may have a climate control system, as is shown schematically at 44. In addition, electric motors 46 may be provided, for example as window winders or as a sliding roof drive. This listing is only by way of example and does not preclude other electrical loads on board a motor vehicle.

### Embodiment A of the Invention

At least one diagram is stored in the electronic control device 4 and represents the relationship between each of a large number of rotation speed values “n”, field current values “IE” and torque values “M” of the electrical machine 8 as a generator for at least one specific vehicle power supply system voltage value. The control device 4 is also designed in order to determine the associated instantaneous drag torque actual value of the electrical machine 8 as a generator from the diagram data on the basis of in each case one rotation speed value “n” and one field current value “IE”The control device 4 is designed to use the respective instantaneous rotation speed actual value and instantaneous field current actual value “IE” of the electrical machine 8 for this purpose. The diagram may in each case be produced for just one specific vehicle power supply system voltage of the vehicle power supply system 28 by tests, because the diagram values change with the vehicle power supply system voltage.

A large number of said diagrams are therefore preferably stored in the control device 4, with each diagram containing said values for a different vehicle power supply system voltage value, and with the control device 4 being designed in order to in each case select that diagram which was produced for that vehicle power supply system voltage value which is closer to the instantaneous vehicle power supply system voltage actual value than the vehicle power supply system voltage value of other diagrams.

According to one preferred embodiment, the control device 4 is designed in order to calculate intermediate values by interpolation in those situations in which the instantaneous vehicle power supply system voltage actual value does not match any of the vehicle power supply system voltage values for which the diagrams were produced.

According to another preferred embodiment of the invention, an algorithm is stored in the control device 4, defining the relationship between the rotation speed “n” and the electrical vehicle power supply system voltage for the electrical machine 8, and the control device 4 is designed in order to use this algorithm to calculate intermediate values in situations in which the instantaneous vehicle power supply system voltage actual value does not match any of the vehicle power supply system voltage values for which the diagrams were produced.

The manufacturer of the electrical machine 8 frequently produces the diagrams only for a limited range of operating values, for example only for field currents of 2 amperes and more, but not for lower field currents and thus not for small torques either. According to one particular embodiment of the invention, an algorithm is therefore stored in the control device 4 for the situation in which the diagram values are stored only for specific value ranges, by means of which algorithm the control device can calculate an instantaneous field current actual value beyond the stored value ranges, in situations in which instantaneous values are located outside the stored value ranges.

FIG. 2 shows one preferred embodiment of diagrams for the electrical machine 8 as a generator, in which the rotation speed values “n” are stored on one diagram axis “n”, the torque values “M” are stored on another diagram axis “M”, and the field currents “IE” are stored as curves IE1, IE2, IE3, up to any desired number IEn in the area between the diagram axes. An algorithm is stored in the control device 4, by means of which the respectively associated third value can in each case be determined, for example can be read or can be calculated, from two different ones of these values.

The control device 4 is preferably designed for any desired one of the abovementioned variants in order to provide open-loop or closed-loop control for the internal combustion engine 6 as a function of the respectively determined instantaneous drag torque actual value “M” of the electrical machine 8, in addition to controlling the internal combustion engine 6 by means of the control device 4 as a function of an external drive torque demand 32, 34, 36 to the motor vehicle 2, such that the control device 4 demands a resultant torque from the internal combustion engine, which resultant torque is composed of the external drive torque demand 32, 34, 36 and at least a portion of the drag torque actual value of the electrical machine 8 in the generator mode.

### Embodiment B of the Invention

In the embodiment B of the invention, at least one diagram is stored in the control device 4, which represents the relationship between a large number of rotation speed values “n”, field current values IE and torque values “M” of the electrical machine 8 as a generator in each case for at least one specific vehicle power supply system voltage value. The control device 4 is designed to determine the associated field current value “IE”, from the diagram data on the basis of in each case one rotation speed value “n” and one torque value “M”, with the control device being designed in order to use a value for this purpose which corresponds to the respective instantaneous rotation speed actual value “n” of the electrical machine 8, and at the same time to use a torque value “M” which is dependent on an external torque demand 32, 34, 36 to the vehicle. The control device 4 then passes a field current value “IE”, which corresponds to the torque value “M” to the electrical machine 8, in order for the electrical machine 8 to at least partially satisfy the external torque demand 32, 34, 36.

The diagram may in each case be produced for only one specific vehicle power supply system voltage of the vehicle power supply system 28 by tests, because the diagram values of the vehicle power supply system voltage vary. A large number of said diagrams are therefore preferably stored in the control device 4, with each diagram including said values for a different vehicle power supply system voltage value, and with the control device 4 being designed in order to in each case select that diagram which was produced for the vehicle power supply system voltage value which is closer to the instantaneous vehicle power supply system voltage actual value than the vehicle power supply system voltage value of other diagrams.

The control device 4 is designed, according to one preferred embodiment, in order to calculate intermediate values by interpolation in those situations in which the instantaneous vehicle power supply system voltage actual value does not match any of the vehicle power supply system voltage values for which the diagrams were produced.

According to another preferred embodiment of the invention, an algorithm is stored in the control device 4 defining the relationship between its rotation speed “n” and the electrical vehicle power supply system voltage for the electrical machine 8, and the control device 4 is designed in order to use this algorithm to calculate intermediate values in situations in which the instantaneous vehicle power supply system voltage actual value does not match any of the vehicle power supply system voltage values for which the diagrams were produced.

The manufacturer of the electrical machine 8 frequently produces the diagrams for only a limited range of operating values, for example only for field currents of 2 amperes and more, but not for lower field currents and thus also not for small torques. According to one particular embodiment of the invention, an algorithm is therefore stored in the control device 4 for situations in which the diagram values are stored only for specific value ranges, by means of which algorithm the control device can calculate an instantaneous field current actual value beyond the stored value ranges in situations in which instantaneous values are located outside the stored value ranges.

FIG. 2 shows one preferred embodiment of diagrams for the electrical machine 8 as a generator, in which the rotation speed values “n” are stored on one diagram axis “n”, the torque values “M” are stored on another diagram axis “M”, and the field currents “IE” are stored as curves IE1, IE2, IE3 up to any desired number IEn in the area between the diagram axes. An algorithm is stored in the control device 4, by means of which the respectively associated third value can in each case be determined, for example can be read or can be calculated, in each case from two different ones of these values.

FIG. 3 shows a diagram for the electrical machine as a generator, in which the rotation speed values “n” are stored on one diagram axis “n”, the field current values “IE” are stored on another diagram axis “IE”, and the torque values “M” are stored as curves M1, M2, M3, . . . , Mn in the area between the diagram axes n, M. An algorithm is stored in the control device 4, by means of which the respectively associated third of these values can be calculated from in each case two different ones of these values.

Each of the two types of diagrams in FIGS. 2 and 3 can be used for both embodiments A and B. The type of diagram in FIG. 2 results, however, in less computation effort by the control device 4 for A, and the diagram type in FIG. 3 results in less computation effort by the control device 4 for B, and thus shorter reaction times in each case. A and B may be joint diagrams, or may each be specific diagrams.

The control device 4 of the embodiment B is preferably designed to set a recuperation braking torque as a function of the external torque demand 32, 34, 36 by means of the field current value at the electrical machine 8, for conversion of the energy of motion of the motor vehicle to electrical power.

According to one particular embodiment of the invention, the control device 4 contains the functions of both embodiments A and B, combined.

One particular advantage of the invention is the prior calculation of the torque of the electrical machine. This means that it is not just possible to use a conventional starter/generator as the electrical machine, but also an electrical machine, for example as a generator, connected via an LIN (LIN: local interconnect network) interface as well, which is a component of the electronic control device 4.

One preferred embodiment C of the invention will be described in the following text, whose features can also be applied to the embodiments A and B.

The electronic control device 4 for this purpose contains functions and algorithms by means of which missing input signals for the coordinator for the control device 4 can be calculated from the output signals from an LIN generator (electrical machine 8 in the generator mode). Among other calculations, the torque variables for the coordinator are also calculated in advance (prior torque calculation).

The function cycle time is, for example 50 ms. All output signals are preferably initialized to the value 0.

If a LIN generator is used instead of a starter/generator, then the LIN generator cannot provide all the signals in the same way as a starter/generator. Since these signals are required in the functions of the coordinator for the control device 4 which are described in the following text, a specific function is provided in the control device, by means of which the missing signals are calculated from LIN generator variables.

The output signals from this function are:

a) Generator current. The instantaneous value of the generator current is determined from one of the families of characteristics that have been mentioned, via the rotation speed and the field current of the generator. A generator identification which is stored in the control device 4 is used to automatically identify which generator is being used, and which family of characteristics should be used. If the instantaneous voltage of the vehicle power supply system differs from the voltage of the family of characteristics, the generator current is appropriately corrected. If the electrical machine 8 (generator) is in the fully driven range, a correction current is determined from the family of characteristics via the rotation speed and voltage, and is calculated with the generator current.

b) Generator efficiency. The instantaneous value of the generator efficiency is determined from the family of characteristics via the rotation speed and the power of the generator. The generator identification is used to identify which generator is installed, and which family of characteristics should be used.

c) Generator torque. The instantaneous value of the generator torque is calculated from the instantaneous value of the current, voltage, efficiency and rotation speed, by the control device 4.

d) Generator charging torque. The instantaneous value of the generator charging torque is calculated from vehicle power supply system variables comprising the charging voltage, the charging current, the generator efficiency and the generator rotation speed, by the control device 4. When in the charging mode (battery charging mode), a change is made to the instantaneous value of the generator torque.

e) Maximum possible steady-state torque. The maximum power which can be drawn from the vehicle power supply system is calculated by the control device 4 from the vehicle power supply system variables comprising the recuperation voltage and the recuperation current. The maximum power of the LIN generator is determined from a characteristic for the rotation speed of the diagram (the generator identification data is used to identify which generator is installed, and which characteristic should be used). The smaller of these two variables is used, and represents the narrower limit for the system. The maximum possible instantaneous torque of the LIN generator is calculated from this variable with the aid of the instantaneous efficiency and the rotation speed.

f) The maximum possible dynamic torque is equal to the maximum possible steady-state torque.

g) Minimum possible steady-state torque. The maximum power which can be emitted from the vehicle power supply system is calculated from the vehicle power supply system variables comprising the minimum voltage and the maximum current. The minimum drag power of the LIN generator is calculated by the control device 4 from an applicable fixed value with the aid of the generator rotation speed (the stored generator identification data is used to identify which generator is installed, and which fixed value should be used). The larger of these two variables is used, and represents the narrow limit for the system. The minimum possible instantaneous torque of the LIN generator is calculated from this variable with the aid of the instantaneous efficiency and the rotation speed.

h) The minimum possible dynamic torque is equal to the minimum possible steady-state torque.

1. An electronic motor vehicle control device for controlling an internal combustion engine and at least one electrical machine, both of which are connected or can be connected for drive purposes to a propulsion train in the motor vehicle, in which case the electrical machine can be operated at least as a generator, but preferably also as an electric motor characterized
in that at least one diagram is stored in the control device, representing the relationship between a large number of rotation speed values, field current values and torque values of the electrical machine in each case as a generator for at least one specific vehicle power supply system voltage value, and in that the control device is designed in order to determine the associated instantaneous drag torque actual value of the electrical machine as a generator from the diagram data on the basis of in each case one rotation speed value and one field current value, with the control device being designed in order to use the respective instantaneous rotation speed actual value and the instantaneous field current actual value of the electrical machine for this purpose.

2. The motor vehicle control device as claimed in claim 1,
characterized
in that a large number of said diagrams are stored, with each diagram containing said values for a different vehicle power supply system voltage value, and in that the control device is designed in order to in each case select that diagram which was produced for the vehicle power supply system voltage value which is closer to the instantaneous vehicle power supply system voltage actual value than the vehicle power supply system voltage value of other diagrams.

3. The motor vehicle control device as claimed in claim 2,
characterized
in that the control device is designed in order to calculate intermediate values by interpolation in those situations in which the instantaneous vehicle power supply system voltage actual value does not match any of the vehicle power supply system voltage values for which the diagrams were produced.

4. The motor vehicle control device as claimed in claim 1,
characterized
in that an algorithm is stored in the control device (4), defining the relationship between the rotation speed and the voltage for the electrical machine, and in that the control device is designed in order to use this algorithm to calculate intermediate values in situations in which the instantaneous vehicle power supply system voltage actual value does not match any of the vehicle power supply system voltage values for which the diagrams were produced.

5. The motor vehicle control device as claimed in claim 1,
characterized
in that the diagram values are stored only for specific value ranges, and in that an algorithm is stored in the control device by means of which the control device can calculate an instantaneous field current actual value beyond the stored value ranges in situations in which values are located outside the stored value ranges.

6. The motor vehicle control device as claimed in claim 1,
characterized
in that, in the diagrams for the electrical machine as a generator, the rotation speed values are stored on one diagram axis, the torque values are stored on another diagram axis, and the field currents are stored as curves in the area between the diagram axes, and in that an algorithm is stored in the control device, by means of which the respectively associated third value can be calculated from two different ones of these values in each case.

7. The motor vehicle control device as claimed in claim 1,
characterized
in that the control device is designed to provide open-loop or closed-loop control for the internal combustion engine as a function of the respectively determined instantaneous drag torque actual value of the electrical machine, in addition to controlling the internal combustion engine by means of the control device as a function of an external drive torque demand to the motor vehicle, such that the control device can demand a resultant torque from the internal combustion engine, which resultant torque is composed of the external drive torque demand and at least a portion of the drag torque actual value of the electrical machine in the generator mode.

8. An electronic motor vehicle control device for controlling an internal combustion engine and at least one electrical machine, both of which are connected or can be connected for drive purposes to a propulsion train in the motor vehicle, in which case the electrical machine can be operated at least as a generator, but preferably also as an electric motor characterized
in that at least one diagram is stored in the control device, representing the relationship between a large number of rotation speed values, field current values and torque values of the electrical machine in each case as a generator for at least one specific vehicle power supply system voltage value, and in that the control device is designed in order to determine the associated control current value from the diagram data on the basis of in each case one rotation speed value and one torque value, with the control device being designed in order to use for this purpose a value which corresponds to the respective instantaneous rotation speed actual value of the electrical machine, and at the same time to use a torque value which is dependent on an external torque demand to the vehicle, with the control device then passing to the electrical machine a field current value which corresponds to that torque value, in order for the electrical machine to at least partially satisfy the external torque demand.

9. The motor vehicle control device as claimed in claim 8,
characterized
in that a large number of said diagrams are stored, with each diagram containing said values for a different vehicle power supply system voltage value, and in that the control device is designed in order to in each case select that diagram which was produced for the vehicle power supply system voltage value which is closer to the instantaneous vehicle power supply system voltage actual value than the vehicle power supply system voltage value of other diagrams.

10. The motor vehicle control device as claimed in claim 9,
characterized
in that the control device is designed in order to calculate intermediate values by interpolation in those situations in which the instantaneous vehicle power supply system voltage actual value does not match any of the vehicle power supply system voltage values for which the diagrams have been produced.

11. The motor vehicle control device as claimed in claim 8,
characterized
in that an algorithm is stored in the control device, defining the relationship between the rotation speed and the voltage for the electrical machine, and in that the control device is designed in order to use this algorithm to calculate intermediate values in situations in which the instantaneous vehicle power supply system voltage actual value does not match any of the vehicle power supply system voltage values for which the diagrams were produced.

12. The motor vehicle control device as claimed in claim 8,
characterized
in that the diagram values are stored only for specific value ranges, and in that an algorithm is stored in the control device by means of which the control device can calculate an instantaneous field current actual value beyond the stored value ranges in situations in which the instantaneous values are located outside the stored value ranges.

13. The motor vehicle control device as claimed in claim 8,
characterized
in that, in the diagrams for the electrical machine as a generator, the rotation speed values are stored on one diagram axis, the torque values are stored on another diagram axis, and the field currents are stored as curves in the area between the diagram axes, and in that an algorithm is stored in the control device, by means of which the respectively associated third value can be calculated from two different ones of these values in each case.

14. The motor vehicle control device as claimed in claim 1,
characterized
in that, in the diagrams for the electrical machine as a generator, the rotation speed values are stored on one diagram axis, the field current values are stored on another diagram axis, and the torque values are stored as curves in the area between the diagram axes, and in that an algorithm is stored in the control device by means of which the respectively associated third of these values can be calculated from two different ones of these values in each case.

15. The motor vehicle control device as claimed in claim 8,
characterized
in that the control device is designed in order to set a recuperation braking torque as a function of an external torque demand by means of the field current value at the electrical machine, in order to convert the energy of motion of the motor vehicle to electrical power.

16. (canceled)

17. The motor vehicle control device as claimed in claim 1,
characterized
in that the control device is designed for clocked checking and calculation of said values, and has a timer for this purpose.

18. The motor vehicle control device as claimed in claim 1,
characterized
in that the control device determines the respective instantaneous rotation speed of the electrical machine as a function of engine control signals for the internal combustion engine and as a function of a mechanical transmission ratio for a drive connection between the propulsion train and the electrical machine.

19. A motor vehicle,
characterized by
an electronic control device as claimed in claim 1.
